(19) United States
(12) Patent Application Publication
(10) Pub. No.: US 2024/0372581 A1
(43) Pub. Date: Nov. 7, 2024

(54) COMPOSITE SIGNAL VIA RECONFIGURABLE INTELLIGENT SURFACE

(71) Applicant: QUALCOMM Incorporated, San Diego, CA (US)

(72) Inventors: Yavuz YAPICI, Florham Park, NJ (US); Junyi LI, Fairless Hills, PA (US)

(21) Appl. No.: 18/311,848

(22) Filed: May 3, 2023

(51) Int. Cl. H04B 7/04; H04W 76/10

(52) U.S. Cl. CPC H04B 7/04013; H04W 76/10

(57) ABSTRACT

Various aspects of the present disclosure generally relate to wireless communication. In some aspects, a user equipment (UE) may establish a connection with a network node. The UE may receive, via a reconfigurable intelligent surface (RIS), a signal that includes at least one composite signal that includes at least one multiplexed non-data signal, wherein a first beamwidth of the at least one composite signal at a first location is narrower than a second beamwidth of the at least one composite signal at a second location that is closer to the RIS than the first location. Numerous other aspects are described.

### FIELD OF THE DISCLOSURE

Aspects of the present disclosure generally relate to wireless communication and to techniques and apparatuses for multiplexing one or more signals via a reconfigurable intelligent surface.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE). The user equipment may include a memory and one or more processors coupled to the memory. The one or more processors may be configured to establish a connection with a network node. The one or more processors may be configured to receive, via a reconfigurable intelligent surface (RIS), at least one composite signal that includes at least one multiplexed non-data signal, wherein a first beamwidth of the at least one composite signal at a first location is narrower than a second beamwidth of the at least one composite signal at a second location that is closer to the RIS than the first location.

Some aspects described herein relate to a network node. The network node may include a memory and one or more processors coupled to the memory. The one or more processors may be configured to establish a connection with a UE. The one or more processors may be configured to configure a RIS to produce a redirected signal that includes at least one composite signal that includes at least one multiplexed non-data signal, wherein a first beamwidth of the redirected signal at a first location is narrower than a second beamwidth of the redirected signal at a second location that is closer to the RIS than the first location.

Some aspects described herein relate to a method of wireless communication performed by a UE. The method may include establishing a connection with a network node. The method may include receiving, via a RIS, at least one composite signal that includes at least one multiplexed non-data signal, wherein a first beamwidth of the at least one composite signal at a first location is narrower than a second beamwidth of the at least one composite signal at a second location that is closer to the RIS than the first location.

Some aspects described herein relate to a method of wireless communication performed by a network node. The method may include establishing a connection with a UE. The method may include configuring a RIS to produce a redirected signal that includes at least one composite signal that includes at least one multiplexed non-data signal, wherein a first beamwidth of the redirected signal at a first location is narrower than a second beamwidth of the redirected signal at a second location that is closer to the RIS than the first location.

Some aspects described herein relate to a non-transitory computer-readable medium that stores a set of instructions by a UE. The set of instructions, when executed by one or more processors of the UE, may cause the UE to establish a connection with a network node. The set of instructions, when executed by one or more processors of the UE, may cause the UE to receive, via a RIS, at least one composite signal that includes at least one multiplexed non-data signal, wherein a first beamwidth of the at least one composite signal at a first location is narrower than a second beamwidth of the at least one composite signal at a second location that is closer to the RIS than the first location.

Some aspects described herein relate to a non-transitory computer-readable medium that stores a set of instructions by a network node. The set of instructions, when executed by one or more processors of the network node, may cause the network node to establish a connection with a UE. The set of instructions, when executed by one or more processors of the network node, may cause the network node to configure a RIS to produce a redirected signal that includes at least one composite signal that includes at least one multiplexed non-data signal, wherein a first beamwidth of the redirected signal at a first location is narrower than a second beamwidth of the redirected signal at a second location that is closer to the RIS than the first location.

Some aspects described herein relate to an apparatus. The apparatus may include means for establishing a connection with a network node. The apparatus may include means for receiving, via a RIS, at least one composite signal that includes at least one multiplexed non-data signal, wherein a first beamwidth of the at least one composite signal at a first location is narrower than a second beamwidth of the at least one composite signal at a second location that is closer to the RIS than the first location.

Some aspects described herein relate to an apparatus. The apparatus may include means for establishing a connection with a UE. The apparatus may include means for configuring a RIS to produce a redirected signal that includes at least one composite signal that includes at least one multiplexed non-data signal, wherein a first beamwidth of the redirected signal at a first location is narrower than a second beamwidth of the redirected signal at a second location that is closer to the RIS than the first location.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features May include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of energy harvesting, in accordance with the present disclosure.

FIG. 5 is a diagram illustrating an example of communications using a reconfigurable intelligent surface (RIS), in accordance with the present disclosure.

FIG. 6 is a diagram illustrating an example of communication links in a wireless network that includes a RIS, in accordance with the present disclosure.

FIG. 7 is a diagram illustrating an example of providing a composite signal via a RIS, in accordance with the present disclosure.

FIG. 8 is a diagram illustrating an example of a signal redirected by a RIS, in accordance with the present disclosure.

FIG. 9 is a diagram illustrating plots of distance-dependent beams produced by a RIS, in accordance with the present disclosure.

FIG. 10 is a diagram illustrating plots of aperture-dependent beams produced by a RIS, in accordance with the present disclosure.

FIG. 11 is a diagram illustrating an example process performed, for example, by a UE, in accordance with the present disclosure.

FIG. 12 is a diagram illustrating an example process performed, for example, by a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

In some examples, a reconfigurable intelligent surface (RIS) may redirect communications between a network node 110 and at least one user equipment (UE). Some UEs may be relatively close to the RIS and some UEs may be relatively far from (and yet within a range of) the RIS. The RIS may use different resources for redirected communications with the closer UE(s) and for the farther UE(s), which may increase overhead.

Various aspects relate generally to wireless communication and more specifically to RISs. Some aspects more specifically relate to multiplexing signals via a RIS. In some examples, a network node and a UE may establish a connection (e.g., a network connection) with each other. The network node may configure the RIS to produce a redirected signal that includes a composite signal that includes at least one multiplexed non-data signal. In some examples, a first beamwidth of the redirected signal at a first location is narrower than a second beamwidth of the redirected signal at a second location that is closer to the RIS than the first location. The network node may output a signal (e.g., to be redirected by the RIS), and the UE may receive the redirected signal via the RIS. The redirected signal may include the composite signal that includes the at least one multiplexed non-data signal.

Particular aspects of the subject matter described in this disclosure can be implemented to realize one or more of the following potential advantages. In some examples, by configuring the RIS to produce the redirected signal, and by receiving the redirected signal, the described techniques can be used to reduce overhead. For example, the redirected signal may enable the RIS to serve one or more relatively close UEs (e.g., at the second location) and one or more relatively far UEs (e.g., at the first location) using the same resources, which may reduce overhead. For example, the RIS may assist in serving one or more nearby UEs and one or more farther UEs using the same resources. For example, the composite signal may be multiplexed in the angular domain, which may enable the RIS to use the same time and frequency resources to multiplex the non-data signal to multiple UEs (e.g., multiple nearby UEs and/or one or more farther UEs).

In some examples, the at least one composite signal may include at least one multiplexed data signal as well as the at least one multiplexed non-data signal, which may enable opportunistic multiplexing of data and non-data. For example, the closer UE may consume the multiplexed non-data signal and the farther UE may consume the multiplexed data signal. Multiplexed non-data signals may include energy-bearing signals or sensing signals. The energy-bearing signals may provide power to energy harvesting (EH) devices. The sensing signals may, for example, yield solutions for multiplexing data and sensing for integrated sensing and communication (ISAC) purposes.

In some aspects, the network node may output, and the UE may receive (e.g., via the RIS) a transmission that includes timing or frequency information of at least one multiplexed non-data signal. The RIS may produce, and the UE may receive, a redirected signal that includes the at least one multiplexed non-data signal (e.g., in one or more resources associated with the timing or frequency information). The timing or frequency information may enable the UE to detect the non-data signal.

In some examples, the network node may configure the RIS, and the UE may receive the redirected signal, based at least in part on an aperture size of the RIS. For instance, the network node may jointly resize and/or configure (e.g., reconfigure) the RIS. Basing the signal at least in part on the aperture size of the RIS may enable wider beams and/or produce a sufficiently large distance-dependent beamwidth to perform multiplexing techniques described herein.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

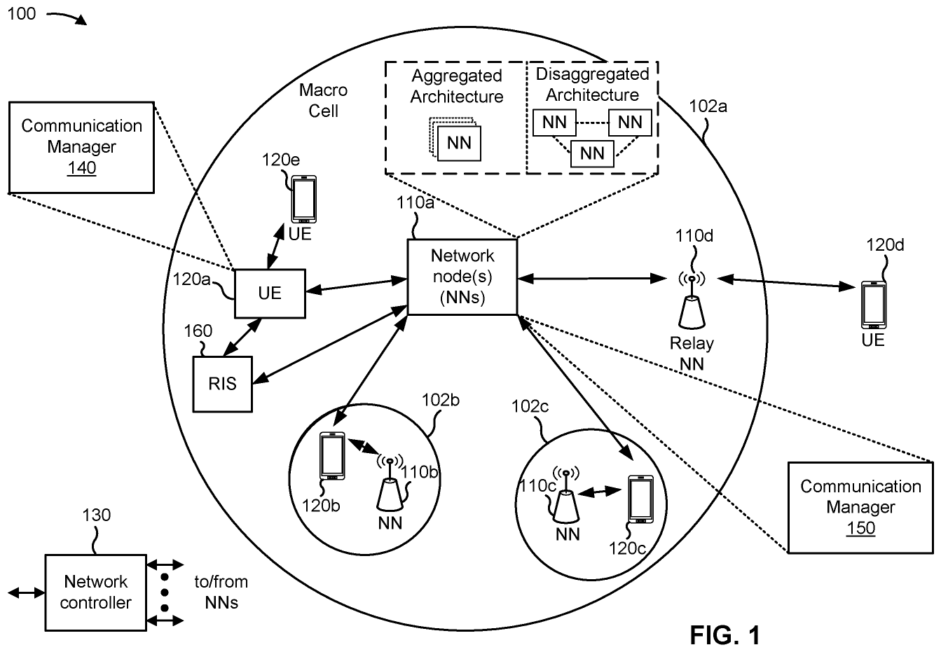

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

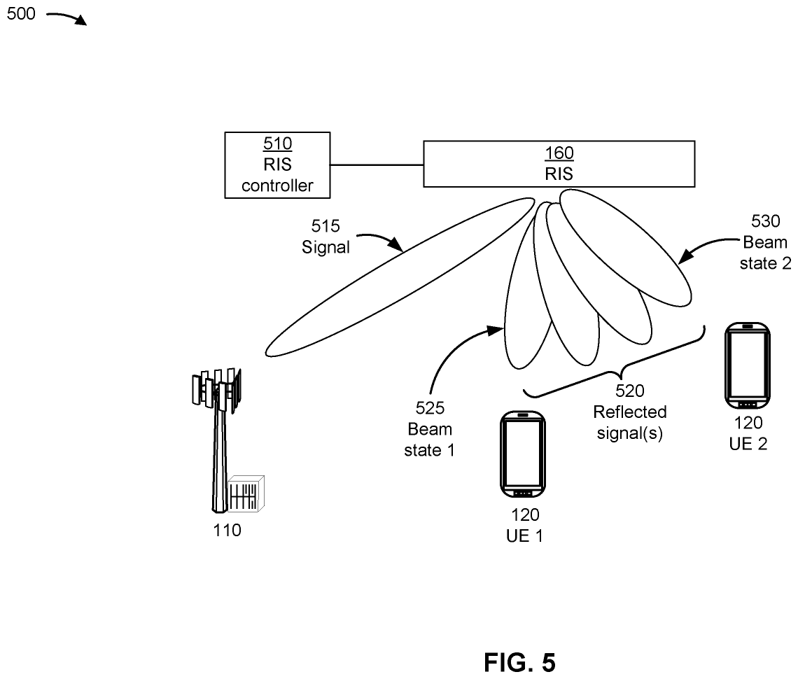

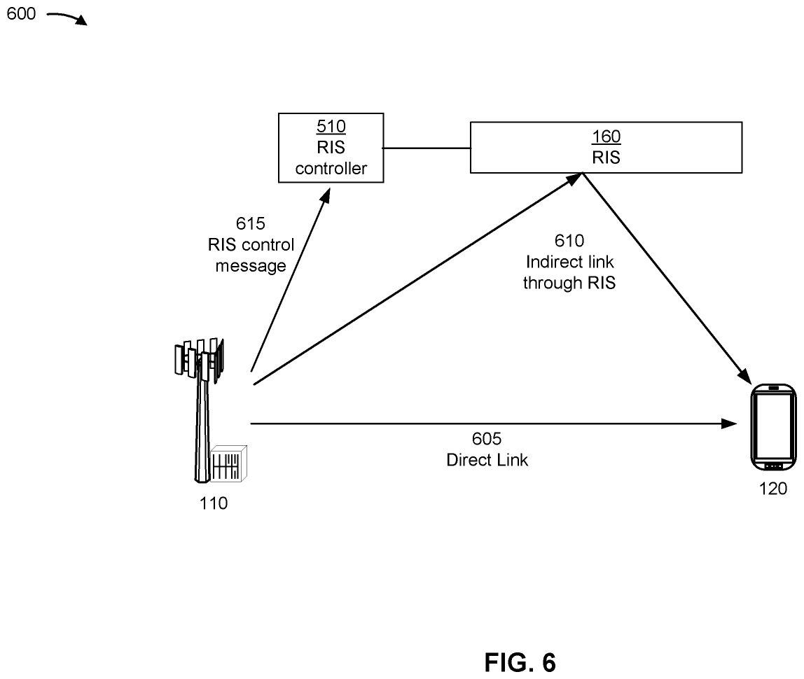

In some aspects, the wireless network 100 may also include a RIS 160. As described in greater detail below in connection with FIGS. 5 and 6, the RIS 160 may include an array of passive and reconfigurable reflecting elements that improves coverage (e.g., by circumventing blockages via new multipaths) at low deployment cost.

In some aspects, the UE 120 may include a communication manager 140. As described in more detail elsewhere herein, the communication manager 140 may establish a connection with a network node; and receive, via the RIS 160, at least one composite signal that includes at least one multiplexed non-data signal, wherein a first beamwidth of the at least one composite signal at a first location is narrower than a second beamwidth of the at least one composite signal at a second location that is closer to the RIS 160 than the first location. Additionally, or alternatively, the communication manager 140 may perform one or more other operations described herein.

In some aspects, the network node 110 may include a communication manager 150. As described in more detail elsewhere herein, the communication manager 150 may establish a connection with the UE 120; and configure the RIS 160 to produce a redirected signal that includes at least one composite signal that includes at least one multiplexed non-data signal, wherein a first beamwidth of the redirected signal at a first location is narrower than a second beamwidth of the redirected signal at a second location that is closer to the RIS 160 than the first location. Additionally, or alternatively, the communication manager 150 may perform one or more other operations described herein.

As indicated above, FIG. 1 is provided as an example. Other examples may differ from what is described with regard to FIG. 1.

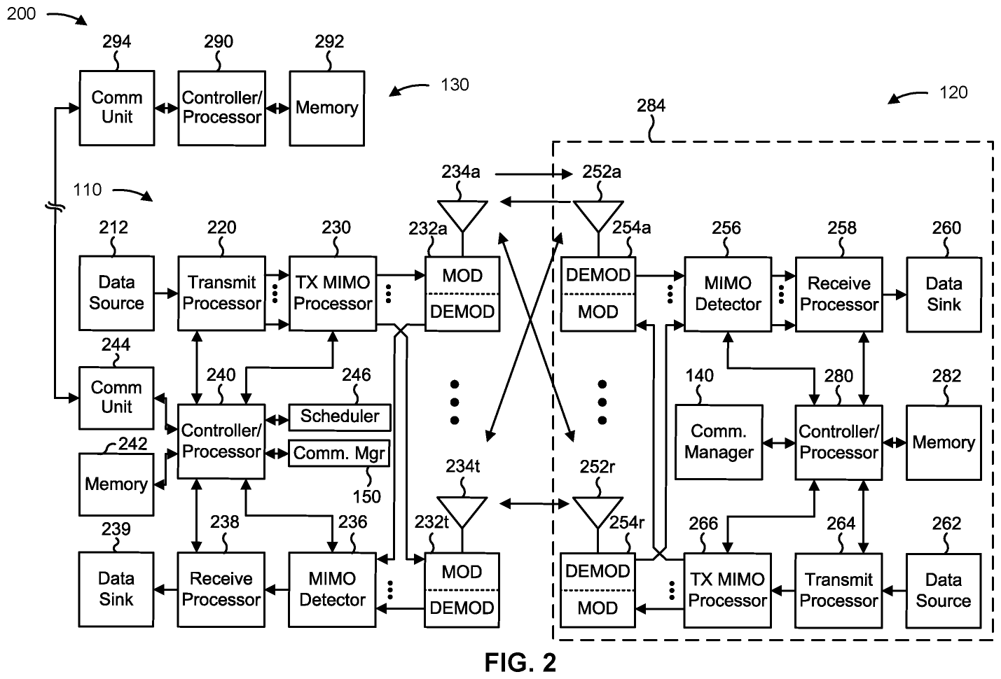

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

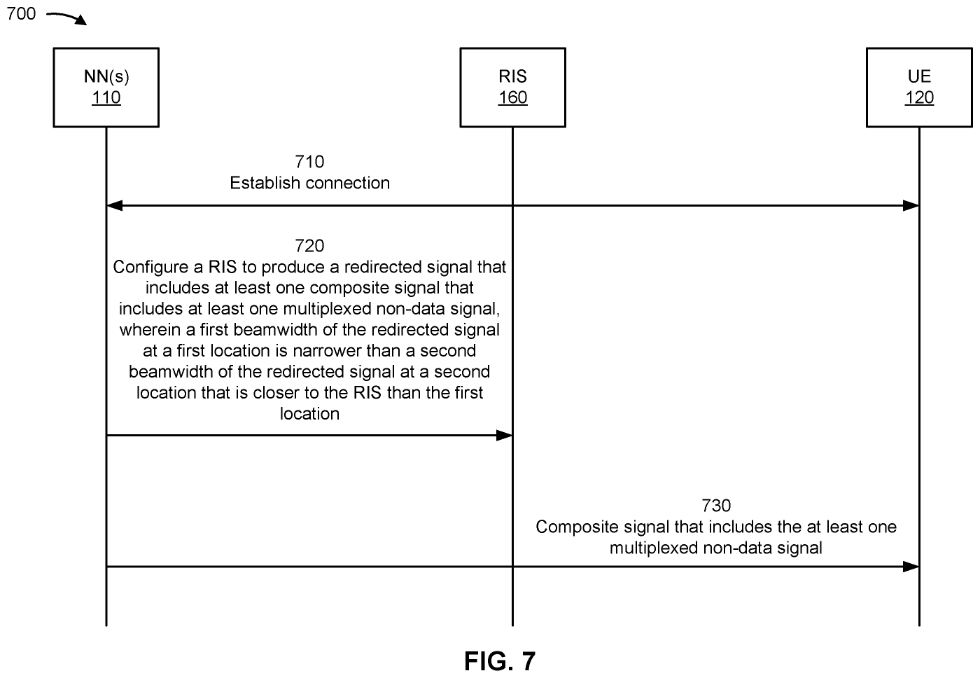

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-14).

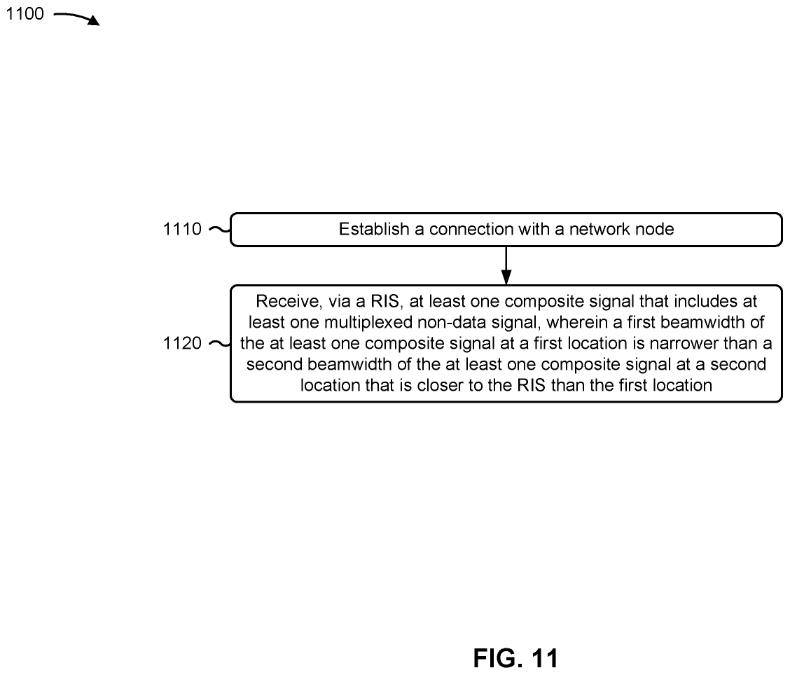

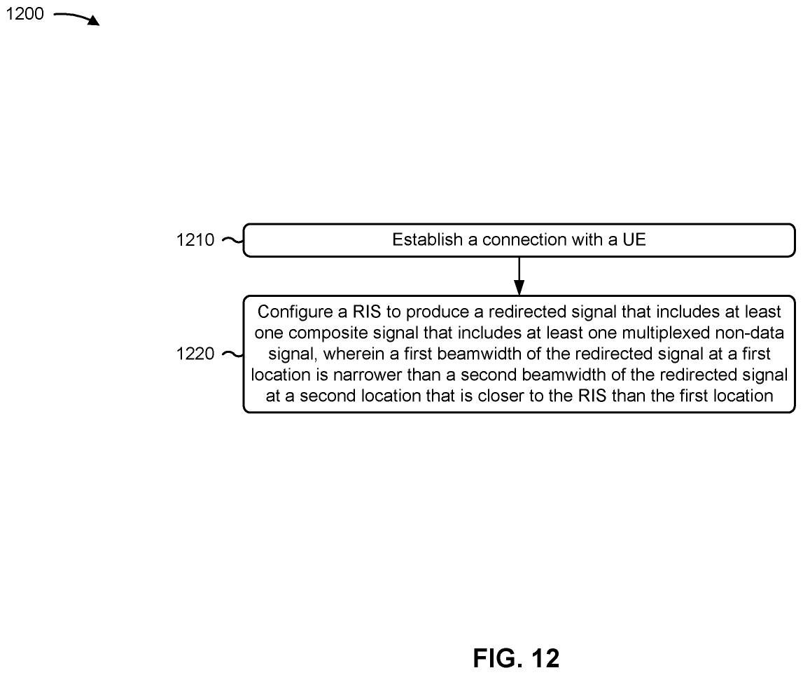

The controller/processor 240 of the network node 110, the controller/processor 280 of the UE 120, and/or any other component(s) of FIG. 2 may perform one or more techniques associated with a composite signal delivered via a RIS, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for establishing a connection with a network node (e.g., using antenna 252, modem 254, MIMO detector 256, receive processor 258, transmit processor 264, TX MIMO processor 266, controller/processor 280, memory 282, or the like); and/or means for receiving, via the RIS 160, at least one composite signal that includes at least one multiplexed non-data signal, wherein a first beamwidth of the at least one composite signal at a first location is narrower than a second beamwidth of the at least one composite signal at a second location that is closer to the RIS 160 than the first location (e.g., using antenna 252, modem 254, MIMO detector 256, receive processor 258, controller/processor 280, memory 282, or the like). The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for establishing a connection with the UE 120 (e.g., using transmit processor 220, TX MIMO processor 230, modem 232, antenna 234, MIMO detector 236, receive processor 238, controller/processor 240, memory 242, or the like); and/or means for configuring the RIS 160 to produce a redirected signal that includes at least one composite signal that includes at least one multiplexed non-data signal, wherein a first beamwidth of the redirected signal at a first location is narrower than a second beamwidth of the redirected signal at a second location that is closer to the RIS 160 than the first location (e.g., using controller/processor 240, transmit processor 220, TX MIMO processor 230, modem 232, antenna 234, memory 242, or the like). The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

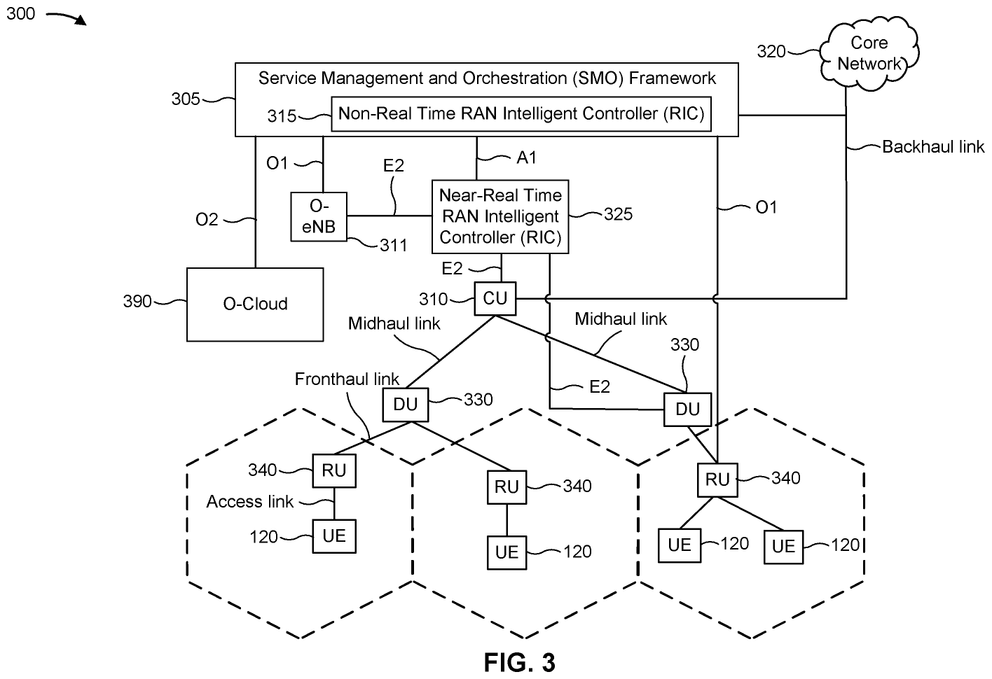

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

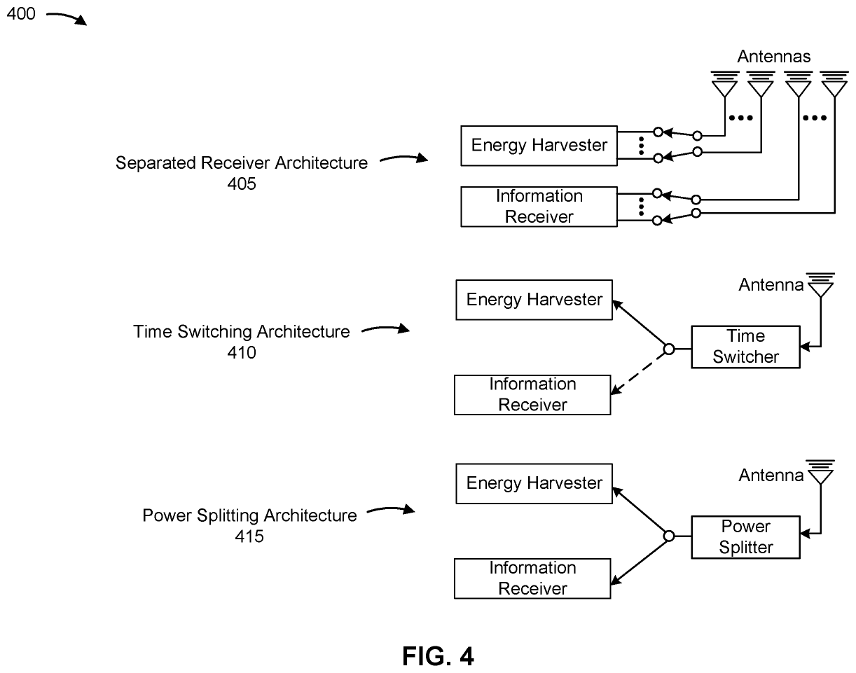

FIG. 4 is a diagram illustrating an example 400 of EH, in accordance with the present disclosure. EH includes obtaining energy from a source other than an on-device energy storage device (e.g., a battery or a capacitor, among other examples). EH may be used to supplement energy obtained from an on-device energy storage device and/or may provide charging to the on-device energy storage device. Devices that use EH (“energy harvesting device” or “EH device”) may have a low-capacity energy storage device (e.g., smart watch) or no energy storage device (e.g., zero power devices, IoT devices, wearables, or financial devices). EH may include converting RF energy transferred from another device. Harvesting RF energy may not provide sufficient energy to fully charge an energy storage device but may be used for performing tasks such as data decoding, operating filters, data reception, data encoding, data reception, and/or data transmission, among other examples. The EH device may accumulate harvested energy over time (e.g., in an on-device energy storage device) to use in a subsequent operation. EH may also be a part of self-sustainable networks, where an EH device in the network may communicate within the network using energy harvested from transmissions of other devices in the network.

As shown in FIG. 4, an EH device (e.g., an RF receiver or a UE 120, among other examples) may receive signals (e.g., radio signals carried on radio waves) from a donor device (e.g., a transmitting device, an RF transmitter, a charging device, a network node 110, or a donor UE 120, among other examples) and convert electromagnetic energy of the signals (e.g., using a rectenna comprising a dipole antenna with an RF diode) into direct current electricity for use by the EH device. The EH device may be a low-power or low-energy device or a zero-power or zero-energy device, among other examples.

As shown by reference number 405, in some aspects, the EH device may use a separated receiver architecture, where a first set of antennas is configured to harvest energy, and a second set of antennas is configured to receive data. In this scenario, each set of antennas may be separately configured to receive signals at certain times, frequencies, and/or via one or more particular beams, such that all signals received by the first set of antennas are harvested for energy, and all signals received by the second set of antennas are processed and/or decoded to receive information or other communications.

As shown by reference number 410, in some aspects, the EH device may use a time-switching architecture to harvest energy. The time switching architecture may use one or more antennas to receive signals, and whether the signals are harvested for energy or processed to receive information depends on the time at which the EH device receives the signals. For example, one or more first time slots may be time slots during which received signals are sent to one or more EH components to harvest energy, and one or more second time slots may be time slots during which received signals are processed and decoded to receive information. In some aspects, the time slots may be pre-configured (e.g., by the EH device, the donor device, or another device).

As shown by reference number 415, in some aspects, the EH device may use a power splitting architecture to harvest energy. The power splitting architecture may use one or more antennas to receive signals, and the signals are handled by one or both of the EH and/or information receiving components according to an EH rate. For example, the EH device may be configured to use a first portion of received signals for EH and the remaining received signals for information receiving. In some aspects, the EH rate may be pre-configured (e.g., by the EH device, the donor device, or another device).

The EH device may receive signals for EH on certain resources (e.g., time, frequency, and/or spatial resources) and at a certain power level that results in a particular charging rate. Energy harvested by the EH device may be used and/or stored for later use. For example, in some aspects, the EH device may be powered directly by the harvested energy. In some aspects, the EH device may use an energy storage device, such as a battery, capacitor, and/or supercapacitor, to gather and store harvested energy for immediate and/or later use.

As indicated above, FIG. 4 is provided as an example. Other examples may differ from what is described with regard to FIG. 4.

FIG. 5 is a diagram illustrating an example 500 of communications using a RIS, in accordance with the present disclosure. As shown in FIG. 5, a network node 110 may communicate with a UE 120 in a wireless network, such as the wireless network 100. The network node 110 and the UE 120 may use the RIS 160 to communicate with one another. For example, the RIS 160 may reflect or redirect a signal to the network node 110 and/or the UE 120. The RIS 160 may also be referred to as an intelligent reflecting surface. In some examples, the RIS 160 may be a repeater.

The RIS 160 may be, or may include, a planar or two-dimensional structure or surface that is designed to have properties to enable a dynamic control of signals or electromagnetic waves reflected and/or redirected by the RIS 160. The RIS 160 may include one or more reconfigurable elements. For example, the RIS 160 may include an array of reconfigurable elements (e.g., an array of uniformly distributed reconfigurable elements). The reconfigurable elements may be elements with a reconfigurable electromagnetic characteristic. For example, the electromagnetic characteristic may include a reflection characteristic (e.g., a reflection coefficient), a scattering characteristic, an absorption characteristic, and/or a diffraction characteristic. The electromagnetic characteristic(s) of each reconfigurable element may be independently controlled and changed over time. The electromagnetic characteristic(s) of each reconfigurable element may be independently configured such that the combination of configured states of the reconfigurable elements reflects an incident signal or waveform in a controlled manner. For example, the reconfigurable elements may be configured to reflect or redirect an impinging signal in a controlled manner, such as by reflecting the impinging signal in a desired direction, with a desired beam width, with a desired phase, with a desired amplitude, and/or with a desired polarization, among other examples. In other words, the RIS 160 may be capable of modifying one or more properties (e.g., direction, beam width, phase, amplitude, and/or polarization) of an impinging signal.

The reconfigurable elements of the RIS 160 may be controlled and/or configured by a RIS controller 510. The RIS controller 510 may be a control module (e.g., a controller and/or a processor) that is capable of configuring the electromagnetic characteristic(s) of each reconfigurable element of the RIS 160. The RIS controller 510 may be associated with certain components similar to the components described in connection with the UE 120 in connection with FIG. 2, such as a modem 254 and/or a similar component for purposes of communicating with a network node 110. The RIS controller 510 may receive control communications (e.g., from a network node 110 and/or a UE 120) indicating one or more properties of reflected signals (e.g., indicating a desired direction, a desired beam width, a desired phase, a desired amplitude, and/or a desired polarization). Therefore, in some examples, the RIS 160 may be capable of receiving communications (e.g., via the RIS 160 and/or the RIS controller 510). In some examples, the RIS 160 and/or the RIS controller 510 may not have transmit capabilities (e.g., the RIS 160 may be capable of reflecting and/or redirecting impinging signals via the reconfigurable elements, but may not be capable of generating and/or transmitting signals). Alternatively, in some examples, the RIS 160 and/or the RIS controller 510 may have transmit capabilities (e.g., the RIS 160 may be capable of reflecting and/or redirecting impinging signals via the reconfigurable elements and may be capable of generating and/or transmitting signals). For example, the RIS 160 and/or the RIS controller 510 may include one or more antennas and/or antenna elements for receiving and/or transmitting signals.

For example, as shown in FIG. 5, the network node 110 may transmit a signal 515. The signal 515 may be transmitted in a spatial direction toward the RIS 160. The RIS 160 may configure the reconfigurable elements of the RIS 160 to reflect and/or redirect the signal 515 in a desired spatial direction and/or with one or more desired signal characteristics (e.g., beam width, phase, amplitude, frequency, and/or polarization). For example, as shown by reference number 520, the RIS 160 may be capable of reflecting the signal 515 in one or more spatial directions. Although multiple beams are shown in FIG. 5 representing different beam states or beam directions of the RIS 160, the RIS 160 may be capable of reflecting a signal with one beam state or one beam direction at a time. For example, in one case, as shown by reference number 525, the RIS 160 may be configured to reflect the signal 515 using a first beam state (e.g., beam state 1). “Beam state” may refer to a spatial direction and/or a beam of a reflected signal (e.g., a signal reflected by the RIS 160). The first beam state may cause the signal 515 to be reflected in a spatial direction toward a first UE 120 (e.g., UE 1). As shown by reference number 530, in another case, the RIS 160 may be configured to reflect the signal 515 using a second beam state (e.g., beam state 2). The second beam state may cause the signal 515 to be reflected in a spatial direction toward a second UE 120 (e.g., UE 2).

The RIS 160 may be deployed in a wireless network (such as the wireless network 100) to improve communication performance and efficiency. For example, the RIS 160 may enable a transmitter (e.g., a network node 110 or a UE 120) to control the scattering, reflection, and refraction characteristics of signals transmitted by the transmitter, to overcome the negative effects of wireless propagation. For example, the RIS 160 may effectively control signal characteristics (e.g., spatial direction, beam width, phase, amplitude, frequency, and/or polarization) of an impinging signal without a need for complex decoding, encoding, and radio frequency processing operations. Therefore, the RIS 160 may provide increased channel diversity for propagation of signals in a wireless network. The increased channel diversity provides robustness to channel fading and/or blocking, such as when higher frequencies are used by the network node 110 and/or the UE 120 (e.g., millimeter wave frequencies and/or sub-terahertz frequencies). Moreover, as the RIS 160 does not need to perform complex decoding, encoding, and radio frequency processing operations, the RIS 160 may provide a more cost and energy efficient manner of reflecting and/or redirecting signals in a wireless network (e.g., as compared to other mechanisms for reflecting and/or redirecting signals, such as a relay device).

As indicated above, FIG. 5 is provided as an example. Other examples may differ from what is described with respect to FIG. 5.

FIG. 6 is a diagram illustrating an example 600 of communication links in a wireless network that includes a RIS, in accordance with the present disclosure. As shown, example 600 includes a network node 110, a UE 120, and the RIS 160. The RIS 160 may be controlled and/or configured by the RIS controller 510.

As shown in FIG. 6, the UE 120 may receive a communication (e.g., data and/or control information) directly from the network node 110 as a downlink communication. Additionally, or alternatively, the UE 120 may receive a communication (e.g., data and/or control information) indirectly from the network node 110 via the RIS 160. For example, the network node 110 may transmit the communication in a spatial direction toward the RIS 160, and the RIS 160 may redirect or reflect the communication to the UE 120.

In some examples, the UE 120 may communicate directly with the network node 110 via a direct link 605. For example, a communication may be transmitted via the direct link 605. A communication transmitted via the direct link 605 between the UE 120 and the network node 110 does not pass through and is not reflected or redirected by the RIS 160. In some examples, the UE 120 may communicate indirectly with the network node 110 via an indirect link 610. For example, a communication may be transmitted via different segments of the indirect link 610. A communication transmitted via the indirect link 610 between the UE 120 and the network node 110 is reflected and/or redirected by the RIS 160. As shown in FIG. 6 and by reference number 615, the network node 110 may communicate with the RIS 160 (e.g., with the RIS controller 510) via a control channel. For example, the network node 110 may indicate, in a RIS control message, spatial direction(s) and/or signal characteristics for signals reflected by the RIS 160. The RIS controller 510 may configure reconfigurable elements of the RIS 160 in accordance with the RIS control message. In some examples, the RIS control message may indicate information associated with the wireless network, such as a frame structure, time synchronization information, and/or slot boundaries, among other examples. Using the communication scheme shown in FIG. 6 may improve network performance and increase reliability by providing the UE 120 with link diversity for communicating with the network node 110.

In some cases, the UE 120 may receive a communication (e.g., the same communication) from the network node 110 via both the direct link 605 and the indirect link 610. In other cases, the network node 110 may select one of the links (e.g., either the direct link 605 or the indirect link 610), and may transmit a communication to the UE 120 using only the selected link. Alternatively, the network node 110 may receive an indication of one of the links (e.g., either the direct link 605 or the indirect link 610) may transmit a communication to the UE 120 using only the indicated link. The indication may be transmitted by the UE 120 and/or the RIS 160. In some examples, such selection and/or indication may be based at least in part on channel conditions and/or link reliability.

As indicated above, FIG. 6 is provided as an example. Other examples may differ from what is described with respect to FIG. 6.

In some examples, one or more UEs may be relatively close to the RIS 160, and one or more UEs may be relatively far from (and yet within a range of) the RIS 160. For example, the RIS 160 may redirect communications between the network node 110 and the farther UE(s), provide energy to one or more EH devices deployed (e.g., as part of a mass IoT deployment) relatively close to the RIS 160, and/or sense the closer UE(s) (e.g., smartphones, cars, drones, etc.) via the RIS 160. The RIS 160 may redirect the communications, provide the energy, and/or perform sensing using respective resources. For example, the RIS 160 may use a first set of resources for the redirected communications, a second set of resources for the energy, and/or a third set of resources for the sensing. Using different resources (e.g., different resources for the relatively close UEs and the relatively far UEs) can increase overhead.

FIG. 7 is a diagram illustrating an example 700 of providing a composite signal via a RIS 160, in accordance with the present disclosure. As shown in FIG. 7, a network node 110 and a UE 120 may communicate with one another via the RIS 160. As shown by reference number 710, the network node 110 and the UE 120 may establish a connection (e.g., a network connection) with each other. For example, the UE 120 may perform a cell search, detect system information outputted by the network node 110, and perform a random access procedure. The network node 110 and the UE 120 may establish the connection via the RIS 160.

As shown by reference number 720, the network node 110 may configure the RIS 160 to produce a redirected signal that includes at least one composite signal that includes at least one multiplexed non-data signal. In some examples, a first beamwidth of the redirected signal at a first location is narrower than a second beamwidth of the redirected signal at a second location that is closer to the RIS 160 than the first location. As shown by reference number 730, the network node 110 may output a signal to be redirected by the RIS 160, and the UE 120 may receive, via the RIS 160, the composite signal that includes the at least one multiplexed non-data signal.

The composite signal may enable the RIS 160 to serve one or more relatively close UEs (e.g., at the second location) and one or more relatively far UEs (e.g., at the first location) using the same resources, which may reduce overhead. For example, the RIS 160 may assist in serving one or more nearby UEs and one or more farther UEs using the same resources. For example, the composite signal may be multiplexed in the angular domain, which may enable the RIS 160 to use the same resources to multiplex the non-data signal to multiple UEs (e.g., multiple nearby UEs and/or one or more farther UEs).

In some examples, the composite signal may include at least one multiplexed data signal as well as at least one multiplexed non-data signal, which may enable opportunistic multiplexing of data and non-data. For example, the closer UE may consume the multiplexed non-data signal, and the farther UE may consume the multiplexed data signal. Multiplexed non-data signals may include energy-bearing (or “power-bearing”) signals or sensing signals. The energy-bearing signals may provide power to EH devices. The sensing signals may, for example, yield solutions for multiplexing data and sensing for ISAC purposes. As used herein, a “multiplexed data signal” may be a control signal (e.g., a signal that includes control or other data), and a “multiplexed non-data signal” may be a signal that includes no data (e.g., no control or other data).

Although both the inputs and the result of the multiplexing operation are often referred to as “multiplexed” signals for simplicity, the result of a multiplexing operation may be referred to as a “composite signal” while the input signals that are multiplexed with each other to generate the composite signal may be referred to as “multiplexed signals.”

As indicated above, FIG. 7 is provided as an example. Other examples may differ from what is described with respect to FIG. 7.

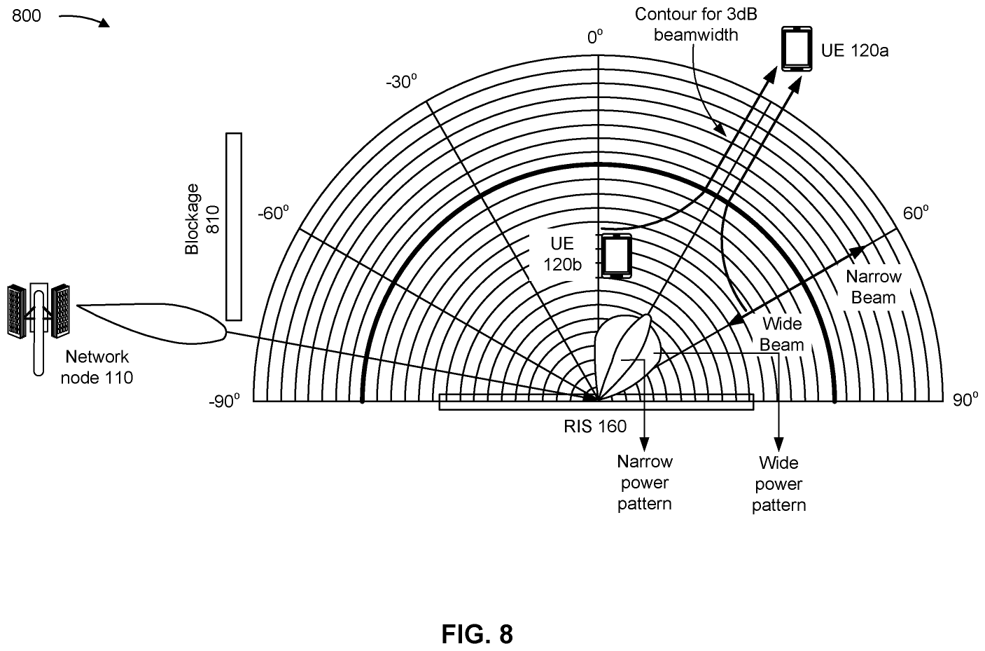

FIG. 8 is a diagram illustrating an example 800 of a signal redirected by the RIS 160, in accordance with the present disclosure. In example 800, the network node 110 outputs a signal via the RIS 160 to UE 120a and to UE 120b.

The UE 120a may be farther from the RIS 160 than then 120b. For example, the UE 120a may be located in the far field (e.g., beyond the Fraunhofer distance from the RIS 160), and the UE 120b may be located in the near field (e.g., within the Fraunhofer distance from the RIS 160). Blockage 810 prevents the network node 110 from communicating directly with UE 120a or with UE 120b.

The RIS 160 may be configured (e.g., reconfigured by the network node 110) to redirect the signal based at least in part on a phase matrix. A phase matrix (which may also be referred to as a free-space matrix) may be a matrix in which each element represents a phase shift applied to an incoming signal (e.g., an incoming signal from the network node 110). Thus, the phase matrix may enable the RIS 160 (e.g., the RIS surface) to produce a redirected signal.

The redirected signal may be a single-lobe beam with distance-dependent beamwidth, which may enable the RIS 160 to serve multiple UEs in respective distance-and-angular locations. The redirected signal may have a narrow beamwidth (e.g., a far-field power pattern less than 5 degrees) at the location of the UE 120a and a wide beamwidth (e.g., a near-field power pattern greater than 5 degrees) at the location of the UE 120b. The narrow power pattern and the wide power pattern may belong to the same RIS beam (or, equivalently, to the same RIS phase matrix), with the narrow power pattern measured by the UE 120a in the far field and the wide power pattern measured at the UE 120b in the near field.

In some examples, the composite signal may include at least one multiplexed signal (e.g., data signal(s) and/or non-data signal(s)). Because of the wide beamwidth near UE 120b, when UE 120a is served with data (e.g., the multiplexed data signal(s)), UE 120b may opportunistically receive the same data that UE 120a is served with or one or more non-data signals (e.g., for EH or sensing applications).

If the RIS 160 serves multiple UEs (e.g., UE 120a and UE 120b) with data, then the UEs may be served with the same data (e.g., the same physical downlink control channel (PDCCH) data with group-common downlink control information (DCI)) because the same time-frequency resources may be used to serve the UEs.

Some aspects may allow for opportunistic multiplexing of data and power. For example, the RIS 160 may serve multiple UEs in a nonorthogonal fashion (e.g., using the same time-frequency resources) such that one or more UEs (e.g., UE 120a) are served with data while one or more other UEs (e.g., UE 120b) are served with non-data signals (e.g., for EH or sensing applications). This type of opportunistic scheduling may enable nearby IoT devices (e.g., UE 120b) to charge using EH techniques while the RIS 160 serves another UE (e.g., UE 120a).

By configuring the RIS 160 with an appropriate phase matrix, the network node 110 may cause the RIS 160 to produce beams having wide beamwidths in the near field, which may enable broadcast-type transmission in the near field using a single-lobe RIS beam. For example, the RIS 160 may multiplex data and power over a RIS-assisted link in a nonorthogonal fashion. Using distance-dependent wide RIS beams, the RIS 160 may serve low-energy (e.g., IoT) devices (e.g., UE 120b) near the RIS 160 with power while serving a primary UE (e.g., UE 120a) with data. For example, the network node 110 may, with the assistance of the RIS 160, serve mass IoT deployments.

As indicated above, FIG. 8 is provided as an example. Other examples may differ from what is described with respect to FIG. 8.

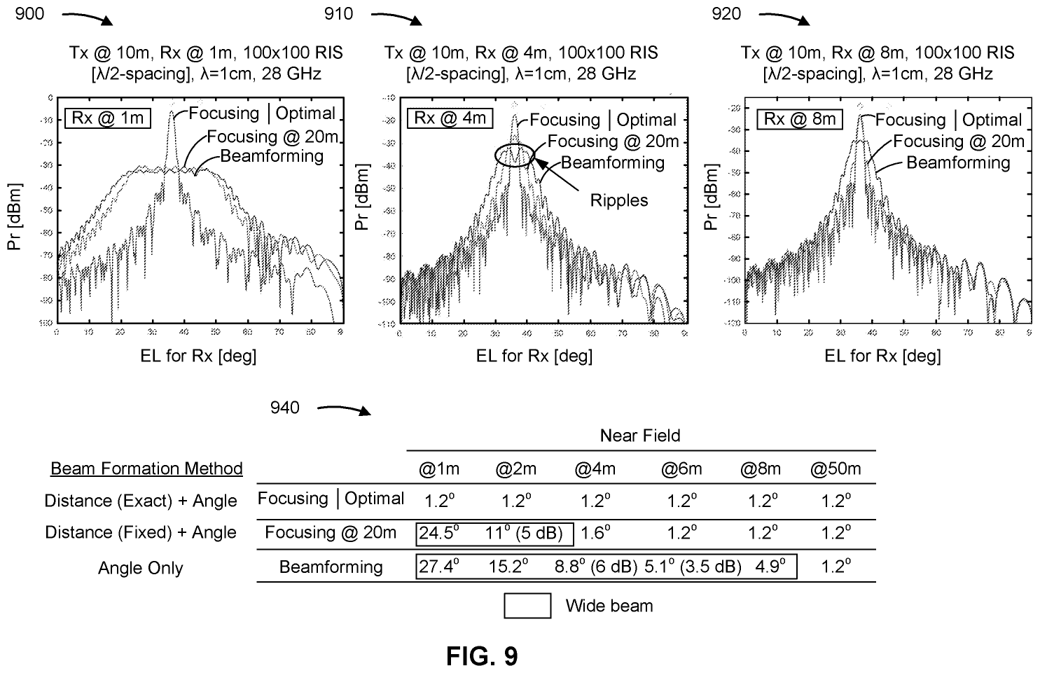

FIG. 9 is a diagram illustrating plots 900, 910, and 920 of distance-dependent beams produced by the RIS 160, in accordance with the present disclosure. Three distance-dependent beams are shown, each based on a respective beam formation scheme: optimal focusing (“Focusing|Optimal”), beamforming, and fixed-point focusing (“Focusing @ 20”). Optimal focusing configures a beam based on angle and distance information of a target UE. Beamforming configures a beam based on angle information (e.g., and not distance information) of a target UE. Fixed-point focusing may configure a beam based on angle information of a target UE and based on a fixed distance (e.g., 20 m).

The beams are shown in plot 900, plot 910, and plot 920. The plots 900-920 illustrate power patterns from angles (45°, 180°) to (36°, 36°) with no loss of signal and 50 dBm EIRP and FSPL. The x-axes of the plots 900-920 represent an angle (also referred to as elevation angle or “EL”), which may be the angle of the redirected signal as shown in FIG. 8. The y-axes of the plots 900-920 represent received power. The plot 900 shows the beams 1 m from the RIS 160, the plot 910 shows the beams 4 m from the RIS 160, and the plot 920 shows the beams 8 m from the RIS 160.

FIG. 9 also includes a table 940 that summarizes the beamwidths of the beams at various distances from the RIS 160. As shown, for beamforming and fixed-point focusing, beamwidth may decrease as distance increases, whereas optimal focusing may be associated with a consistently narrow beam. Thus, the beamwidth for beamforming and fixed-point focusing may be wide for nearby locations (e.g., for near-field power patterns) and narrow for farther locations (i.e., for far-field power patterns). As a result, beamforming and fixed-point focusing may be suitable beam formation techniques for implementations described herein. However, it may be desirable to avoid the ripples in the beam produced by the beamforming technique as shown in the plot 910.

As indicated above, FIG. 9 is provided as an example. Other examples may differ from what is described with respect to FIG. 9.

An example interaction between the network node 110, the RIS 160, the UE 120a, and the UE 120b is provided as follows. In some examples, while serving the UE 120a with the assistance of the RIS 160, the network node 110 may collect channel-quality measurements from the UE 120a. The network node 110 may collect the channel-quality measurements periodically (e.g., as configured by one or more RRC messages) or dynamically (e.g., in a DCI-triggered fashion). If the network node 110 determines that a target quality of service (QOS) is satisfied with a given RIS configuration (e.g., a RIS configuration that is based on beamforming or fixed-point focusing), then the network node 110 may reconfigure the RIS 160 with the RIS configuration such that the RIS 160 produces a beam with a distance-dependent beamwidth.

If the UE 120b is to receive the same data that the UE 120a is receiving, then the UE 120b may opportunistically receive the data after performing a cell discovery procedure (e.g., decoding the master information block (MIB), decoding the system information block 1 (SIB1), detecting the PDCCH, decoding the physical downlink shared channel (PDSCH), or the like).

In some examples (e.g., EH or sensing applications), the UE 120b may not consume the data that the UE 120a is receiving. For example, if the UE 120b is an EH device, then the UE 120b may harvest energy using the data signals or using dedicated EH signals. If the UE 120b is a power-requesting UE configured to harvest energy using the signals that are already being transmitted (e.g., the data signals such as PDCCH, PDSCH, or the like), then the network node 110 may continue to transmit those signal (e.g., without further modification of the signals or transmission procedures). If the UE 120b is a power-requesting UE configured to harvest energy using dedicated EH signals, then the network node 110 may indicate how the UE 120b is to detect those dedicated signals.

In some examples, the network (e.g., wireless network 100) may inform the network node 110 that one or more EH devices (e.g., power-requesting, such as IoT devices) are close to the RIS 160. Based on the proximity of the EH device(s) to the RIS 160, the network node 110 may prioritize a RIS configuration associated with a wide beam (e.g., using beamforming or fixed-point focusing) to opportunistically serve the EH device(s) with power. For example, during RIS selection, the network node 110 may select a RIS (e.g., the RIS 160), from among multiple RISs, that has EH IoT devices nearby.

Some aspects described herein relate to scheduling non-data signals, such as dedicated power-bearing signals or dedicated sensing signals. The network node 110 may inform the nearby EH UEs (e.g., UE 120b), over one or more control channels, of scheduling for the one or more dedicated signals that are designed for EH or sensing applications upon reception of the dedicated signal(s) by the UE 120b. For example, the network node 110 may signal, over the RIS link, the scheduling for the power-bearing signals to be harvested by one or more low-energy devices.

In some aspects, the network node 110 may output, and the UE 120b may receive (e.g., via the RIS 160) a transmission that includes timing or frequency information of at least one multiplexed non-data signal (e.g., a dedicated power-bearing or dedicated sensing signal). The RIS 160 may produce, and the UE 120b may receive, a redirected signal that includes the at least one multiplexed non-data signal (e.g., in one or more resources associated with the timing or frequency information). Thus, the timing or frequency information may enable the UE 120b to detect the non-data signal.

In some examples, the transmission that includes the timing or frequency information of the at least one multiplexed non-data signal included in the composite signal further includes timing or frequency information of at least one multiplexed data signal that is also included in the composite signal. For example, the network node 110 may output, and the UE 120b may receive, the timing and/or frequency information of one or more data signals and the timing and/or frequency information of one or more non-data (e.g., power-bearing) signals in a PDCCH with DCI fields (e.g., DCI fields configured to communicate the timing and/or frequency information). In some examples, any UEs that are not to perform the EH (e.g., legacy UEs) may discard the DCI fields. If the UE 120b is also to receive the data signal(s), then the UE 120b may determine where to find data signals and non-data signals after a single blind deconvolution. Therefore, including the timing or frequency information of the at least one multiplexed non-data signal and the timing or frequency information of the at least one multiplexed data signal in the transmission beneficial for the energy efficiency of the UE 120b.

In some examples, the transmission that includes the timing or frequency information of the at least one multiplexed non-data signal is a first transmission. The network node 110 may output, and the UE 120b may receive (e.g., via the RIS 160), a second transmission that includes timing or frequency information of at least one multiplexed data signal. The first and second transmission may be transmitted (e.g., outputted by the network node 110 and received by the UE 120b) in the same search space.

For example, the network node 110 may output the timing and frequency information of non-data signals in a dedicated PDCCH that is separate from, but uses the same common search space (CSS) as, a PDCCH that carries the timing and frequency information of data signals. For example, the dedicated PDCCH for the non-data signals may use the same control resource set (CORESET) 0 and CSS as, and may use a different DCI format and/or scrambling sequence from, the PDCCH for the data signals. In some examples, the UE 120b may decode any PDCCH within the search space to identify the PDCCH for non-data signals. Including the first transmission and the second transmission in the same search space may enable the network node 110 and the UE 120b to use the same MIB for the first transmission and the second transmission, which may avoid imposing requirements on the network node 110 to transmit different MIBs.

In some examples, the transmission that includes the timing or frequency information of the at least one multiplexed non-data signal is a first transmission. The network node 110 may output, and the UE 120b may receive (e.g., via the RIS 160), a second transmission that includes timing or frequency information of at least one multiplexed data signal. The first transmission and the second transmission may be transmitted (e.g., outputted by the network node 110 and received by the UE 120b) in different search spaces. This may impact the MIB, which may define multiple search spaces (e.g., a first search space and the CSS). Including the first transmission and the second transmission in different search spaces may enable the UE 120b to avoid unnecessary blind deconvolution (because the UE 120b may determine the location of the relevant PDCCH), which may improve the energy efficiency of the UE 120b.

Some aspects may allow for aperture adaptation. For example, in addition to (or instead of) reconfiguring the RIS 160 with an appropriate phase matrix, the network node 110 may adjust or otherwise control an aperture size of the RIS 160. For example, the RIS 160 may be configured or reconfigured (e.g., based on aperture adaptation) and/or selected for multiplexing of data and non-data.

In some examples, the network node 110 may configure the RIS 160, and a UE 120 may receive the signal, based at least in part on an aperture size of the RIS 160. For instance, the network node 110 may jointly resize and/or configure (e.g., reconfigure) the RIS 160. Basing the signal at least in part on the aperture size of the RIS 160 may enable wider beams and/or produce a sufficiently large distance-dependent beamwidth to perform multiplexing techniques described herein.

For example, the aperture size may be an active aperture size of the RIS 160. The network node 110 may increase the quantity of active elements on the RIS 160, which may increase the aperture size of the RIS 160. The network node 110 may adjust the active aperture size of the RIS 160 and reconfigure the RIS 160 using beamforming, optimal focusing, and/or fixed-point focusing techniques.

In some energy-efficient RIS operations, for instance, only a portion of the overall RIS aperture may be in use (e.g., the active aperture size of the RIS 160 is less than the total aperture size of the RIS 160), which may reduce power consumption. In such energy-efficient RIS operations, the network node 110 may adjust (e.g., increase) the active aperture size. Basing the signal at least in part on the active aperture size of the RIS 160 may enable the RIS 160 to produce the target large beamwidth at close distances (e.g., in energy-efficient RIS scenarios).

In some examples, the network node 110 may select the RIS 160 from among a plurality of RISs based at least in part on the aperture size of the RIS 160. For example, during a RIS selection procedure, the network node 110 may choose the RIS 160, from among multiple candidates RISs, based on the RIS 160 having a sufficiently large size (e.g., aperture size) to be able to produce the target large beamwidth at close distances.

The network node 110 may select the RIS 160 (e.g., a larger RIS) even if the candidate RISs include a smaller RIS that can satisfy the QoS requirements of the UE 120a along the boresight, because the larger RIS 160 may also be capable of producing the large beamwidth at close distances. For example, the network node 110 may choose the biggest RIS (e.g., the RIS having the most elements). In some examples, the network node 110 may base the RIS selection on the respective power consumption requirements of the candidate RISs. Selecting the RIS 160 from among a plurality of RISs based at least in part on the aperture size of the RIS 160 may enable help to ensure that the RIS 160 (e.g., the RIS selected during a beam selection procedure) can produce the signal described herein.

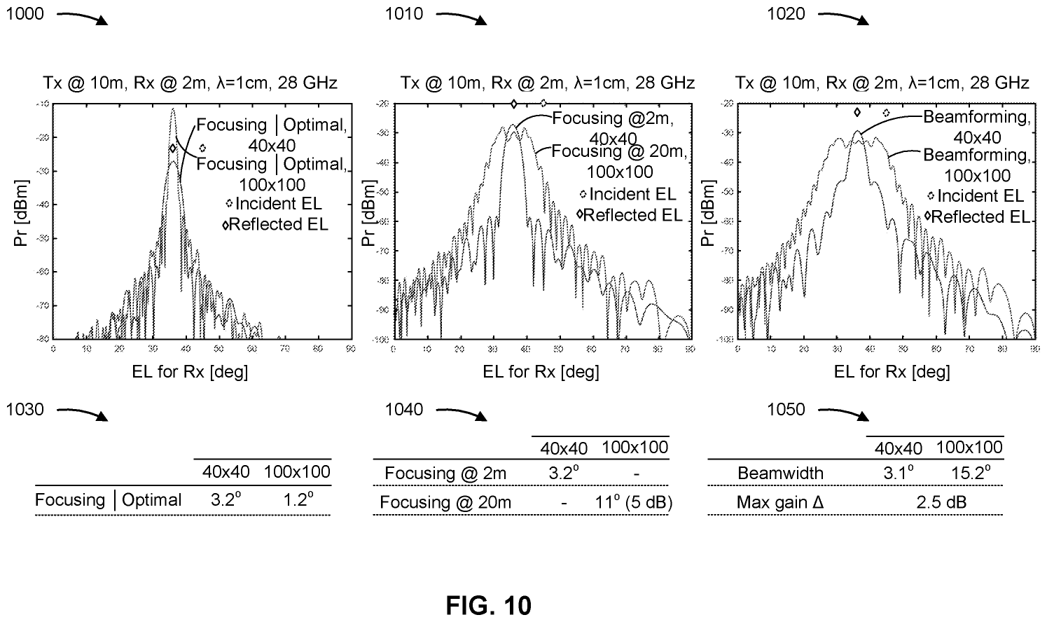

FIG. 10 is a diagram illustrating plots 1000, 1010, and 1020 of aperture-dependent beams produced by the RIS 160, in accordance with the present disclosure. Plot 1000 shows two distance-dependent beams formed based on optimal focusing. Plot 1010 shows two distance-dependent beams formed based on beamforming. Plot 1020 shows two distance-dependent beams formed based on fixed-point focusing. The two distant-dependent beams shown in plots 1000-1020 are produced by a 40-element-by-40-element aperture and a 100-element-by-100-element aperture.

The plots 1000-1020 illustrate power patterns from angles (45°, 180°) to (36°, 36°) with no loss of signal and 50 dBm EIRP and FSPL. The x-axes of the plots 1000-1020 represent the EL, which may be the angle of the redirected signal as shown in FIG. 8. The y-axes of the plots 1000-1020 represent received power.

FIG. 10 also includes tables 1030-1050 that summarize the beamwidths of the beams at various distances from the RIS 160 for respective plots 1000-1020. As shown, the target wide beams may be obtained by selecting a larger RIS aperture (e.g., 100-element-by-100-element aperture) if the RIS beam formation is performed based on either beamforming (e.g., angle-only based beamforming) or fixed-point focusing (e.g., angle-and-distance-based beamfocusing with a fixed-focusing distance).

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 120) performs operations associated with providing a composite signal via a RIS.

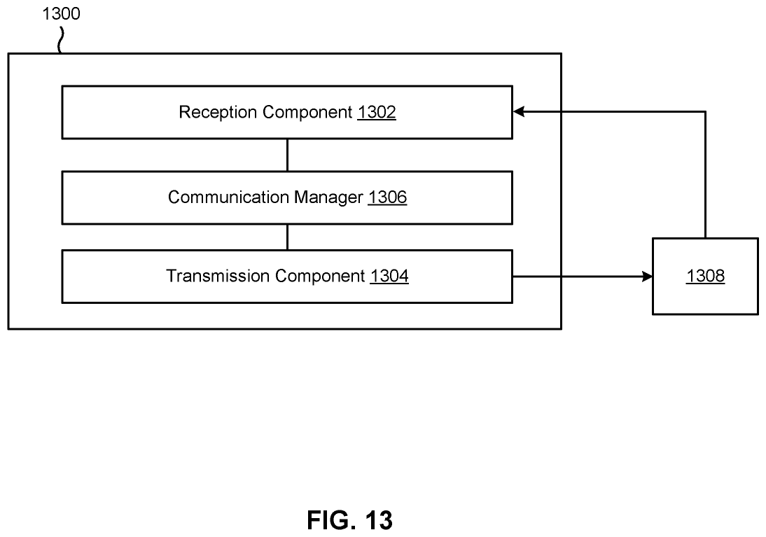

As shown in FIG. 11, in some aspects, process 1100 may include establishing a connection with a network node (block 1110). For example, the UE (e.g., using communication manager 140 and/or communication manager 1306, depicted in FIG. 13) may establish a connection with a network node, as described above, for example, with reference to FIGS. 7, 8, 9, and/or 10.

As further shown in FIG. 11, in some aspects, process 1100 may include receiving, via a RIS, a signal that includes at least one composite signal that includes at least one multiplexed non-data signal, wherein a first beamwidth of the at least one composite signal at a first location is narrower than a second beamwidth of the at least one composite signal at a second location that is closer to the RIS than the first location (block 1120). For example, the UE (e.g., using communication manager 140 and/or reception component 1302, depicted in FIG. 13) may receive, via a RIS, a signal that includes at least one composite signal that includes at least one multiplexed non-data signal, wherein a first beamwidth of the at least one composite signal at a first location is narrower than a second beamwidth of the at least one composite signal at a second location that is closer to the RIS than the first location, as described above, for example, with reference to FIGS. 7, 8, 9, and/or 10.

Process 1100 may include additional aspects, such as any single aspect or any combination of aspects described below and/or in connection with one or more other processes described elsewhere herein.

In a first aspect, the RIS is configured to redirect the at least one composite signal based at least in part on a phase matrix.

In a second aspect, alone or in combination with the first aspect, the process 1100 further comprises receiving a transmission that includes timing or frequency information of the at least one multiplexed non-data signal.

In a third aspect, alone or in combination with one or more of the first and second aspects, the at least one composite signal further includes at least one multiplexed data signal, and the transmission further includes timing or frequency information of the at least one multiplexed data signal.

In a fourth aspect, alone or in combination with one or more of the first and second aspects, the at least one composite signal further includes at least one multiplexed data signal, the transmission is a first transmission, receiving the first transmission includes receiving the first transmission in a search space, and the process 1100 further includes receiving, in the search space, a second transmission that includes timing or frequency information of the at least one multiplexed data signal.

In a fifth aspect, alone or in combination with one or more of the first and second aspects, the at least one composite signal further includes at least one multiplexed data signal, the transmission is a first transmission, receiving the first transmission includes receiving the first transmission in a first search space, and the process 1100 further includes receiving, in a second search space, a second transmission that includes timing or frequency information of the at least one multiplexed data signal.

In a sixth aspect, alone or in combination with one or more of the first through fifth aspects, receiving the at least one composite signal includes receiving the at least one composite signal based at least in part on an aperture size of the RIS.

In a seventh aspect, alone or in combination with one or more of the first through sixth aspects, the aperture size is an active aperture size of the RIS.

In an eighth aspect, alone or in combination with one or more of the first through seventh aspects, the RIS is a first RIS that is selected from among a plurality of RISs based at least in part on the aperture size of the first RIS.

In a ninth aspect, alone or in combination with one or more of the first through eighth aspects, the at least one composite signal includes at least one multiplexed data signal as well as the at least one multiplexed non-data signal.

In a tenth aspect, alone or in combination with one or more of the first through ninth aspects, the at least one multiplexed non-data signal includes at least one multiplexed power-bearing signal.

In an eleventh aspect, alone or in combination with one or more of the first through tenth aspects, the at least one multiplexed non-data signal includes at least one multiplexed sensing signal.

In a twelfth aspect, alone or in combination with one or more of the first through eleventh aspects, the at least one composite signal is multiplexed in an angular domain.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with providing a composite signal via a RIS.

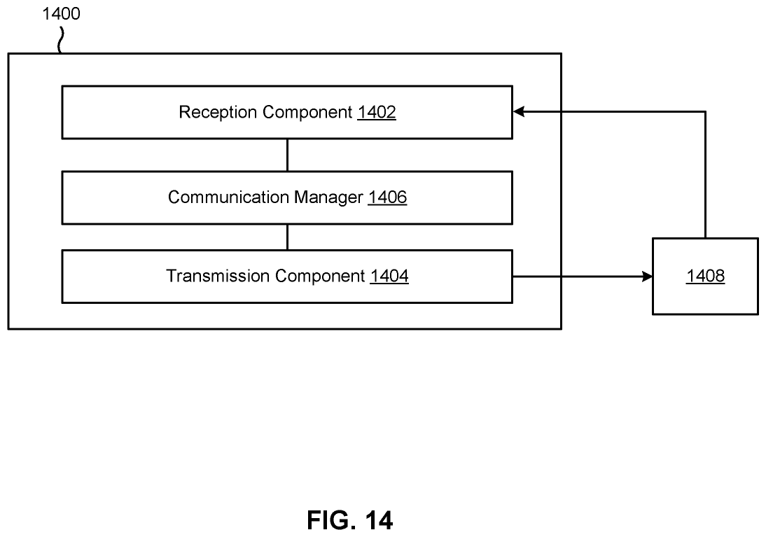

As shown in FIG. 12, in some aspects, process 1200 may include establishing a connection with a UE (block 1210). For example, the network node (e.g., using communication manager 150 and/or communication manager 1406, depicted in FIG. 14) may establish a connection with a UE, as described above, for example, with reference to FIGS. 7, 8, 9, and/or 10.

As further shown in FIG. 12, in some aspects, process 1200 may include configuring a RIS to produce a redirected signal that includes at least one composite signal that includes at least one multiplexed non-data signal, wherein a first beamwidth of the redirected signal at a first location is narrower than a second beamwidth of the redirected signal at a second location that is closer to the RIS than the first location (block 1220). For example, the network node (e.g., using communication manager 150 and/or communication manager 1406, depicted in FIG. 14) may configure a RIS to produce a redirected signal that includes at least one composite signal that includes at least one multiplexed non-data signal, wherein a first beamwidth of the redirected signal at a first location is narrower than a second beamwidth of the redirected signal at a second location that is closer to the RIS than the first location, as described above, for example, with reference to FIGS. 7, 8, 9, and/or 10.

Process 1200 may include additional aspects, such as any single aspect or any combination of aspects described below and/or in connection with one or more other processes described elsewhere herein.

In a first aspect, configuring the RIS includes configuring the RIS to produce the redirected signal based at least in part on a phase matrix.

In a second aspect, the process 1200 further includes outputting a transmission that includes timing or frequency information of the at least one multiplexed non-data signal.

In a third aspect, alone or in combination with one or more of the first and second aspects, the at least one composite signal further includes at least one multiplexed data signal, and the transmission further includes timing or frequency information of the at least one multiplexed data signal.

In a fourth aspect, alone or in combination with one or more of the first and second aspects, the at least one composite signal further includes at least one multiplexed data signal, the transmission is a first transmission, outputting the first transmission includes outputting the first transmission in a search space, and the process 1200 further includes outputting, in the search space, a second transmission that includes timing or frequency information of the at least one multiplexed data signal.

In a fifth aspect, alone or in combination with one or more of the first and second aspects, the at least one composite signal further includes at least one multiplexed data signal, the transmission is a first transmission, outputting the first transmission includes outputting the first transmission in a first search space, and the process 1200 further includes outputting, in a second search space, a second transmission that includes timing or frequency information of the at least one multiplexed data signal.

In a sixth aspect, alone or in combination with one or more of the first through fifth aspects, configuring the RIS includes configuring the RIS based at least in part on an aperture size of the RIS.

In a seventh aspect, alone or in combination with one or more of the first through sixth aspects, the aperture size is an active aperture size of the RIS.

In an eighth aspect, alone or in combination with one or more of the first through seventh aspects, the RIS is a first RIS, and the process 1200 further includes selecting the first RIS from among a plurality of RISs based at least in part on the aperture size of the first RIS.

In a ninth aspect, alone or in combination with one or more of the first through eighth aspects, the at least one composite signal includes at least one multiplexed data signal as well as the at least one multiplexed non-data signal.

In a tenth aspect, alone or in combination with one or more of the first through ninth aspects, the at least one multiplexed non-data signal includes at least one multiplexed power-bearing signal.

In an eleventh aspect, alone or in combination with one or more of the first through tenth aspects, the at least one multiplexed non-data signal includes at least one multiplexed sensing signal.

In a twelfth aspect, alone or in combination with one or more of the first through eleventh aspects, the at least one composite signal is multiplexed in an angular domain.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 7-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The communication manager 1306 may establish a connection with a network node. The reception component 1302 may receive, via a RIS, at least one composite signal that includes at least one multiplexed non-data signal, wherein a first beamwidth of the at least one composite signal at a first location is narrower than a second beamwidth of the at least one composite signal at a second location that is closer to the RIS than the first location.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 7-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The communication manager 1406 may establish a connection with a UE. The communication manager 1406 may configure a RIS to produce a redirected signal that includes at least one composite signal that includes at least one multiplexed non-data signal, wherein a first beamwidth of the redirected signal at a first location is narrower than a second beamwidth of the redirected signal at a second location that is closer to the RIS than the first location.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a UE, comprising: establishing a connection with a network node; and receiving, via a RIS, at least one composite signal that includes at least one multiplexed non-data signal, wherein a first beamwidth of the at least one composite signal at a first location is narrower than a second beamwidth of the at least one composite signal at a second location that is closer to the RIS than the first location.

Aspect 2: The method of Aspect 1, wherein the RIS is configured to redirect the at least one composite signal based at least in part on a phase matrix.

Aspect 3: The method of any of Aspects 1-2, further comprising: receiving a transmission that includes timing or frequency information of the at least one multiplexed non-data signal.

Aspect 4: The method of Aspect 3, wherein the at least one composite signal further includes at least one multiplexed data signal, and wherein the transmission further includes timing or frequency information of the at least one multiplexed data signal.

Aspect 5: The method of Aspect 3, wherein the at least one composite signal further includes at least one multiplexed data signal, wherein the transmission is a first transmission, and wherein receiving the first transmission includes receiving the first transmission in a search space, and wherein the method further comprises: receiving, in the search space, a second transmission that includes timing or frequency information of the at least one multiplexed data signal.

Aspect 6: The method of Aspect 3, wherein the at least one composite signal further includes at least one multiplexed data signal, wherein the transmission is a first transmission, and wherein receiving the first transmission includes receiving the first transmission in a first search space, and wherein the method further comprises: receiving, in a second search space, a second transmission that includes timing or frequency information of the at least one multiplexed data signal.

Aspect 7: The method of any of Aspects 1-6, wherein receiving the at least one composite signal includes: receiving the at least one composite signal based at least in part on an aperture size of the RIS.

Aspect 8: The method of Aspect 7, wherein the aperture size is an active aperture size of the RIS.

Aspect 9: The method of Aspect 7, wherein the RIS is a first RIS that is selected from among a plurality of RISs based at least in part on the aperture size of the first RIS.

Aspect 10: The method of any of Aspects 1-9, wherein the at least one composite signal includes at least one multiplexed data signal as well as the at least one multiplexed non-data signal.

Aspect 11: The method of any of Aspects 1-10, wherein the at least one multiplexed non-data signal includes at least one multiplexed power-bearing signal.

Aspect 12: The method of any of Aspects 1-11, wherein the at least one multiplexed non-data signal includes at least one multiplexed sensing signal.

Aspect 13: The method of any of Aspects 1-12, wherein the at least one composite signal is multiplexed in an angular domain.

Aspect 14: A method of wireless communication performed by a network node, comprising: establishing a connection with a UE; and configuring a RIS to produce a redirected signal that includes at least one composite signal that includes at least one multiplexed non-data signal, wherein a first beamwidth of the redirected signal at a first location is narrower than a second beamwidth of the redirected signal at a second location that is closer to the RIS than the first location.

Aspect 15: The method of Aspect 14, wherein configuring the RIS includes: configuring the RIS to produce the redirected signal based at least in part on a phase matrix.

Aspect 16: The method of any of Aspects 14-15, further comprising: outputting a transmission that includes timing or frequency information of the at least one multiplexed non-data signal.

Aspect 17: The method of Aspect 16, wherein the at least one composite signal further includes at least one multiplexed data signal, and wherein the transmission further includes timing or frequency information of the at least one multiplexed data signal.

Aspect 18: The method of Aspect 16, wherein the at least one composite signal further includes at least one multiplexed data signal, wherein the transmission is a first transmission, and wherein outputting the first transmission includes outputting the first transmission in a search space, and wherein the method further comprises: outputting, in the search space, a second transmission that includes timing or frequency information of the at least one multiplexed data signal.

Aspect 19: The method of Aspect 16, wherein the at least one composite signal further includes at least one multiplexed data signal, wherein the transmission is a first transmission, and wherein outputting the first transmission includes outputting the first transmission in a first search space, and wherein the method further comprises: outputting, in a second search space, a second transmission that includes timing or frequency information of the at least one multiplexed data signal.

Aspect 20: The method of any of Aspects 14-19, wherein configuring the RIS includes: configuring the RIS based at least in part on an aperture size of the RIS.

Aspect 21: The method of Aspect 20, wherein the aperture size is an active aperture size of the RIS.

Aspect 22: The method of Aspect 20, wherein the RIS is a first RIS, the method further comprising: selecting the first RIS from among a plurality of RISs based at least in part on the aperture size of the first RIS.

Aspect 23: The method of any of Aspects 14-22, wherein the at least one composite signal includes at least one multiplexed data signal as well as the at least one multiplexed non-data signal.

Aspect 24: The method of Aspect 14-23, wherein the at least one multiplexed non-data signal includes at least one multiplexed power-bearing signal.

Aspect 25: The method of Aspect 14-24, wherein the at least one multiplexed non-data signal includes at least one multiplexed sensing signal.

Aspect 26: The method of any of Aspects 14-25, wherein the at least one composite signal is multiplexed in an angular domain.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
establish a connection with a network node; and
receive, via a reconfigurable intelligent surface (RIS), at least one composite signal that includes at least one multiplexed non-data signal, wherein a first beamwidth of the at least one composite signal at a first location is narrower than a second beamwidth of the at least one composite signal at a second location that is closer to the RIS than the first location.

2. The UE of claim 1, wherein the RIS is configured to redirect the at least one composite signal based at least in part on a phase matrix.

3. The UE of claim 1, wherein the one or more processors are further configured to:
receive a transmission that includes timing or frequency information of the at least one multiplexed non-data signal.

4. The UE of claim 3, wherein the at least one composite signal further includes at least one multiplexed data signal, and wherein the transmission further includes timing or frequency information of the at least one multiplexed data signal.

5. The UE of claim 3, wherein the at least one composite signal further includes at least one multiplexed data signal, wherein the transmission is a first transmission, and wherein the one or more processors, to receive the first transmission, are configured to receive the first transmission in a search space, and
wherein the one or more processors are further configured to:
receive, in the search space, a second transmission that includes timing or frequency information of the at least one multiplexed data signal.

6. The UE of claim 3, wherein the at least one composite signal further includes at least one multiplexed data signal, wherein the transmission is a first transmission, and wherein the one or more processors, to receive the first transmission, are configured to receive the first transmission in a first search space, and
wherein the one or more processors are further configured to:
receive, in a second search space, a second transmission that includes timing or frequency information of the at least one multiplexed data signal.

7. The UE of claim 1, wherein the one or more processors, to receive the at least one composite signal, are configured to:
receive the at least one composite signal based at least in part on an aperture size of the RIS.

8. The UE of claim 7, wherein the aperture size is an active aperture size of the RIS.

9. The UE of claim 7, wherein the RIS is a first RIS that is selected from among a plurality of RISs based at least in part on the aperture size of the first RIS.

10. The UE of claim 1, wherein the at least one composite signal includes at least one multiplexed data signal as well as the at least one multiplexed non-data signal.

11. The UE of claim 1, wherein the at least one multiplexed non-data signal includes at least one multiplexed power-bearing signal.

12. The UE of claim 1, wherein the at least one multiplexed non-data signal includes at least one multiplexed sensing signal.

13. The UE of claim 1, wherein the at least one composite signal is multiplexed in an angular domain.

14. A network node for wireless communication, comprising:
a memory; and
one or more processors, coupled to the memory, configured to:
establish a connection with a user equipment (UE); and
configure a reconfigurable intelligent surface (RIS) to produce a redirected signal that includes at least one composite signal that includes at least one multiplexed non-data signal, wherein a first beamwidth of the redirected signal at a first location is narrower than a second beamwidth of the redirected signal at a second location that is closer to the RIS than the first location.

15. The network node of claim 14, wherein the one or more processors, to configure the RIS, are configured to:
configure the RIS to produce the redirected signal based at least in part on a phase matrix.

16. The network node of claim 14, and wherein the one or more processors are further configured to:
output a transmission that includes timing or frequency information of the at least one multiplexed non-data signal.

17. The network node of claim 14, wherein the one or more processors, to configure the RIS, are configured to:
configure the RIS based at least in part on an aperture size of the RIS.

18. The network node of claim 14, wherein the at least one composite signal includes at least one multiplexed data signal as well as the at least one multiplexed non-data signal.

19. The network node of claim 14, wherein the at least one composite signal is multiplexed in an angular domain.

20. A method of wireless communication performed by a user equipment (UE), comprising:
establishing a connection with a network node; and
receiving, via a reconfigurable intelligent surface (RIS), at least one composite signal that includes at least one multiplexed non-data signal, wherein a first beamwidth of the at least one composite signal at a first location is narrower than a second beamwidth of the at least one composite signal at a second location that is closer to the RIS than the first location.

21. The method of claim 20, wherein the RIS is configured to redirect the at least one composite signal based at least in part on a phase matrix.

22. The method of claim 20, further comprising:
receiving a transmission that includes timing or frequency information of the at least one multiplexed non-data signal.

23. The method of claim 20, wherein receiving the at least one composite signal includes:
receiving the at least one composite signal based at least in part on an aperture size of the RIS.

24. The method of claim 20, wherein the at least one composite signal includes at least one multiplexed data signal as well as the at least one multiplexed non-data signal.

25. The method of claim 20, wherein the at least one composite signal is multiplexed in an angular domain.

26. A method of wireless communication performed by a network node, comprising:
establishing a connection with a user equipment (UE); and
configuring a reconfigurable intelligent surface (RIS) to produce a redirected signal that includes at least one composite signal that includes at least one multiplexed non-data signal, wherein a first beamwidth of the redirected signal at a first location is narrower than a second beamwidth of the redirected signal at a second location that is closer to the RIS than the first location.

27. The method of claim 26, wherein configuring the RIS includes:
configuring the RIS to produce the redirected signal based at least in part on a phase matrix.

28. The method of claim 26, further comprising:
outputting a transmission that includes timing or frequency information of the at least one multiplexed non-data signal.

29. The method of claim 26, wherein configuring the RIS includes:
configuring the RIS based at least in part on an aperture size of the RIS.

30. The method of claim 26, wherein the at least one composite signal includes at least one multiplexed data signal as well as the at least one multiplexed non-data signal.
